(19) United States
(12) Patent Application Publication
(10) Pub. No.: US 2004/0150988 A1
(43) Pub. Date: Aug. 5, 2004

(54) Torch that is switched on and off by means of impact or movement of the wrist joint

(76) Inventors: Christophe Mermaz, Luton (GB); Dominique Pecquet, Luton (GB)

Correspondence Address: Mermaz Christophe, Britannia House, Light Emotions, Lea Grave Road, Luton Beds, LU3 IRJ, GB

(21) Appl. No.: 10/470,532

(22) PCT Filed: Jan. 30, 2002
(86) PCT No.: PCT/FR02/00363

(30) Foreign Application Priority Data
Jan. 30, 2001 (FR) 0101661

(51) Int. Cl. F21L 2/00

(52) U.S. Cl. 362/157

(57) ABSTRACT

The invention relates to an analogue lighting element, light stick or torch of the type that comprises a body containing at least one power source (H) and at least one light source (I) powered by said power source and a power supply switch for the light source. Said switch comprises a first electrical contact (lateral pad) and a second electrical contact (B). The power supply circuit for the light source is closed by moving the power source from top to bottom, a movement which puts or leaves a pole of the power source in contact with said first contact and which puts the other pole of the power source in contact with said second contact of a lower pad. The movement can result from a simple manual impact or a simple movement of the wrist joint.

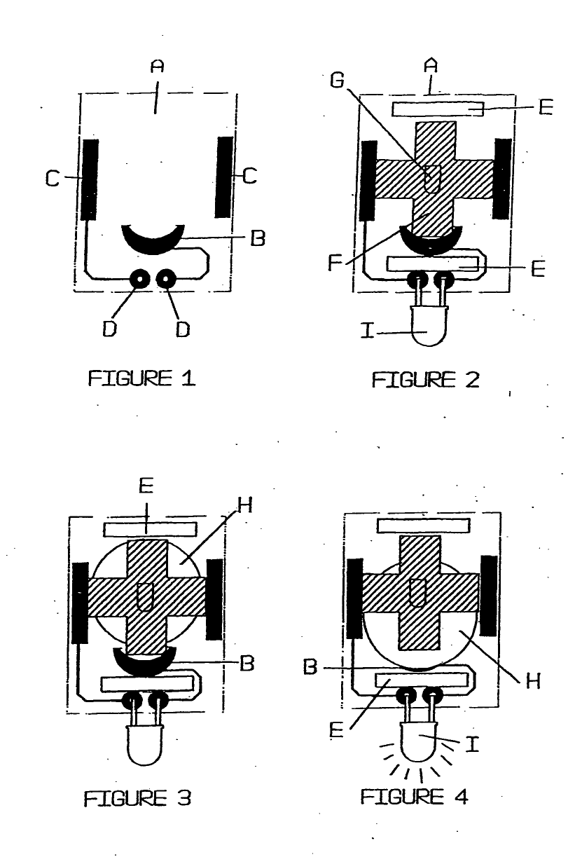

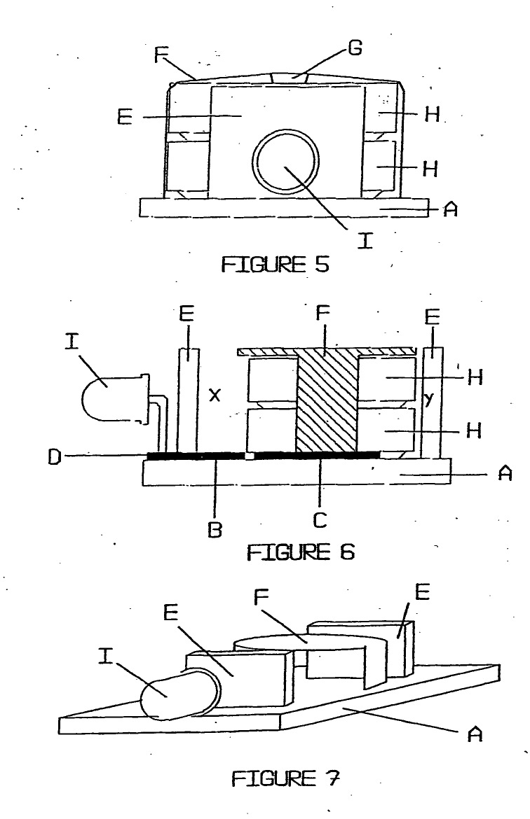

### TECHNICAL AREA OF THE INVENTION

The present invention concerns the glow-in-the-dark device sector, such as torches, glow sticks and similar items, used in all sort of events, or such as safety light in caravanning, boating, mountaineering and similar use, possibly disposable.

The invention could also be used in the fishing industry.

Technical Issue

For the above-listed items we are looking to improve the user-friendly aspect, lightness, reliability of the switch system, and the power source longevity. We are also looking for compatible dimensions according to the expected use.

Existing patents

We are aware of various glow-in-the-dark devices powered by at least one battery. We are also aware of the existence of glow-in-the-dark distress systems with pyrotechnic switch on. We do not know of any other system gathering the entire above-listed characteristics, some of them being conflicting. The cost of our technology is sufficiently low for the system to be disposable and to allow the use by the general public.

### INVENTION SUMMARY

The device according to the invention forms a glow-in-the-dark torch, glow-in-the-dark stick or similar glow-in-the-dark devices, by general and convenient use it will be named below as “torch”, is composed of a body containing at least one electric power source and at least one lighting source supplied by the one electric power source, and an on-off switch for the lighting source. The on-off switch is characterized by the fact that it includes a first electric contact (side pad) and a second electric contact, and by the fact that the closure of the electrical circuit is made by the power source movement, which remains connected or gets connected to the terminal of the power source with the first electric contact and get connected to the other power source terminal with the second electric contact.

### DETAILED DESCRIPTION OF THE INVENTION

Preferably, the first terminal of the power source is continuously connected with the first contact of the lighting source circuit.

Preferably, the first terminal of the power source is connected with the first contact of the lighting source circuit by the movement of the power source.

Preferably, the movement of the power source is a translation driven between maintaining elements. The power source is sufficiently tight between those two elements not to be able to move freely, e.g. with gravity, but not enough to prevent a translation movement under a force in the direction of its free motion degree.

Preferably but not in a restrictive way, the two maintaining elements are two parallel plates. These plates define a space, which represents the degree of freedom of the power source placed between those two plates.

Preferably but not in a restrictive way, the two maintaining elements are two parallel plates forming a clip.

Preferably, at least one of the maintaining elements forms a constant electric contact with one of the power source terminal, which is connected to the lighting source.

According to a variant and not restrictive way of execution, the invention device contains at least one electric pad, placed at the end of the free motion space of the power source between the two maintaining elements, the contact being constantly connected with the lighting source.

The device according to the invention is adapted to enable the movement of the power source in such a way so as to close the power circuit of the lighting source. This will happen thanks to the connection between the first power source terminal and the maintaining elements, and the connection between the second power source terminal and the electric pad. The maintaining elements and the pad being both electrically connected to the lighting source, whenever the movement of the power source in the opposite direction opens the power circuit of the lighting source by disconnecting the second power source terminal and the electrical pad.

As a variant, the power source movement could also, in one direction, connects each power source terminals, with respectively an electric contact in the maintaining element and the electric pad, which closes the power circuit and lights up the lighting source. In the other direction, the power source movement disconnects the electric contact between each power source terminals and respectively the electric contact in the maintaining element and the electric pad.

Preferably, the power source is a round small battery (small electrical battery).

Preferably, the power source is formed of two batteries, connected in parallel, and separated by a non-conducting element, e.g. a thin plastic plate.

In such a case, one battery contains a first terminal connected to an electric contact on one side of the device, and a second terminal connected to the electrical pad. The other battery contains a first terminal connected to an electric contact on the other side of the device, and a second terminal connected to the pad.

We also can consider that the two electrical contacts will be on the same side of the device, but separated by an electric insulator. We will also place two electric pads separated by an electric insulator. Therefore two independent circuits will supply the lighting source.

Preferably, the lighting source is a LED (light emitting diode).

Preferably, the battery or batteries movement is induced by a tap on one of the side of the device. This will cause a movement in the expected direction, or—by the movement of the device capable of generating a centrifugal strength in the expected direction—the tap or centrifugal strength will be sufficient to overcome the rubbing resistance induced by the maintaining elements. It is obvious that any professional user will understand that the tap or the strength will be applied on the free motion direction of the battery or batteries.

Other characteristics and advantages of this invention will be better understood by reading the following description and by referring to the drawings hereunder:

Drawing 1 schematically shows a setting according to the invention comprising two side contacts C and a lower pad B, with an electric circuit CD and BD, where D represents the two lighting source terminals.

Drawing 2 schematically shows a setting according to the invention, where the lighting source I, the two stops E which limit the battery or batteries movement and a clip F including the two contacts C are shown.

Preferably, the clip has an element G forming a rubbing element or spring, which prevents the batteries from moving freely.

Drawing 3 shows drawing 2 with a battery H on a high position, which opens the power circuit, the LED is switched off

Drawing 4 shows drawing 2 with a battery H on a low position, following the movement sustained, the circuit is now closed thanks to the contact between the battery and the contact C, the LED lights up.

Drawing 5 to 7 shows a not restrictive way of execution containing two superposed batteries.

We did not detail the body of the invention, which could have many forms: torch, stick, sphere, disc, of any form and section required

The device can be adapted in any existing items (pacifier, disguise mask, clothes, etc.).

### EXAMPLE

The device can be made of one printed circuit board (A) comprising pads (C) allowing to solder one clip (F) in order to maintain small electronic batteries (H) connected to one of the pads (D) enabling to mount a LED or a bulb. The other pad (D) of the lighting source (1) is connected to a pad (B) intending to receive one of the lower battery (H) terminals.

The clip (F) is designed to maintain the batteries (H), prohibiting an “X” direction movement, but allowing a “Y” direction movement. It includes a spring—(G) in order to insure the electric contact to the upper battery (H). Two stops (E) stamped or welded on the board (A), disable the batteries (H) to get out of the clip (F).

System: Once the device is assembled, the action of knocking the device on a hard surface (or beating or shaking it with your hand) on the opposite side from the lighting source (I) produces the battery (H) movement, removing them from the pad (B). By the way the LED or bulb is not supplied (light off). By beating the device on the other side (lighting source's side), the battery (H) removal allows the lower batteries (H) to get connected with the pad (B) and it automatically switches on the LED or bulb circuit (light on).

As a non-restrictive example, a prototype has been made according to the drawings, the negative terminal of the lower battery (H) is connected or not to the pad (B) depending of the device state, and the positive terminal of the upper battery (H) is continuously connected with the string (G) of the clip (F).

Preferably, the item is a torch incorporating the device according to the invention e.g. on one of its extremity. The LED could be alternatively switched on or off by a simple wrist movement producing an accommodated centrifugal force on the torch extremity.

The invention also covers any similar items of various kind, and any variant ways of execution with many batteries, LEDs, etc. . . . .

The invention also covers various ways of implementation and any applications, which will be directly accessible to professional users by reading this application thoroughly, and by making some simple test.

1. Glow-in-the-dark torch, glow-in-the-dark stick by general and convenient use will be named below as “torch”, composed of a body containing at least one electric power source (H), at least one lighting source (1) powered by the said power source, and an on-off switch of the lighting source. The on-off switch is characterized by the fact that it includes a first electrical contact (C) and a second electrical contact (B), and by the fact that the closure of the electrical circuit is made by the power source movement, which keeps connected or gets connected to the first terminal of the power source with the first electric contact (C) and connects to the other power source terminal with the second electric contact (B).

2. According to paragraph 1, a torch characterised by the fact that the first terminal of the electric power source is continuously connected to the first contact of the lighting source circuit.

3. According to paragraph 1, a torch characterised by the fact that the first terminal of the electric power source is connected to the first contact of the lighting source circuit consequently to the power source movement.

4. A torch—according to any of the paragraph 1 to 3—characterised by the fact that the power source movement is a translation conducted between two maintaining elements (F), the power source being sufficiently tight (a spring or rubbing element G) between those two elements in order to restrict free movement, e.g. with gravity, but insufficiently in order to able to move in translation under a force in the direction of its free motion degree.

5. A torch—according to any of the paragraph 1 to 4—characterised by the fact that the two maintaining elements (F) are two parallel plates. These plates define a space, which represents the degree of freedom of the power source placed between those two plates

6. A torch—according to any of the paragraphs 1 to 5—characterised by the fact that the two maintaining elements are two parallel plates forming a clip.

7. A torch—according to any of the paragraphs 1 to 6—characterised by the fact that at least one of the maintaining element forms a permanent electrical connection (C) with one of the power source terminal, which is electrically connected with a terminal (D) of the lighting source.

8. A torch—according to any of the paragraph 1 to 7—characterised by the fact that there is at least one conducting electrical pad (B), placed at one end of the free movement space of the power source between the two maintaining elements (F), the said conducting pad being electrically connected with a (D) terminal of the lighting source (1).

9. A torch—according to any of the paragraph 1 to 8—characterised by the fact the movement of the power source (H) in a first direction closes the power circuit of the lighting source, thanks to the connection between the first power source terminal and the maintaining element (C), and between the second power source terminal and the electric pad (B). The maintaining elements and the pad being each electrically connected to the lighting source terminals (D), whereas the movement of the power source in the opposite direction opens the power circuit of the lighting source by disconnecting the second power source terminal and said electrical pad (B)

10. A torch—according to any of the paragraph 1 to 8—characterised by the fact that the power source movement, in one direction, also connects each power source terminals, to respectively an electric contact (C) in the maintaining element and respectively the electrical pad, which closes the power circuit and lights up the lighting source. In the other direction, the power source movement disconnects the electric contact between each power source terminals and respectively the electric contact (C) in the maintaining element and respectively the electrical pad (B).

11. A torch—according to any of the paragraphs 1 to 10—characterised by the fact that the power source is formed by a round battery (small electronics battery).

12. A torch—according to any of the paragraph 1 to 10—characterised by the fact that the power source contains two batteries connected in parallel, and separated by a non-conducting partition elements, e.g. a thin plastic plate.

13. A torch—according to paragraph 12—characterised by the fact that that the two electrical contacts (C) will be on the same side of the device, but separated by an electrical insulator. Also we will place two electric pads (B) separated by an electric insulator, therefore two independent circuits will supply the lighting source.

14. A torch—according to any of the paragraph 1 to 13—characterised by the fact that the lighting source is a LED (light emitting diode).

15. A torch—according to any of the paragraph 1 to 14—characterised by the fact that the battery or batteries movement is induced by a tap on one side of the device capable of generating a centrifugal strength in the expected direction, the tap or centrifugal force being sufficient to overcome the rubbing resistance induced by the maintaining elements (F)(G).
